(19) United States
(12) Patent Application Publication
(10) Pub. No.: US 2009/0235825 A1
(43) Pub. Date: Sep. 24, 2009

(54) SYSTEM FOR PREPARING A BEVERAGE SUITABLE FOR CONSUMPTION AND EXCHANGEABLE HOLDER FOR SUCH SYSTEM

(76) Inventors: Gerbrand Kristiaan De Graaff, Lisse (NL); Hendrik Cornelis Koeling, Amersfoort (NL); Ka Cheung Tsang, Amsterdam (NL); Ralf Kamerbeek, Utrecht (NL)

Correspondence Address: FOLEY & LARDNER LLP, 777 EAST WISCONSIN AVENUE, MILWAUKEE, WI, 53202-5306, US

(21) Appl. No.: 12/297,623

(22) PCT Filed: Apr. 19, 2007
(86) PCT No.: PCT/NL2007/050166

§ 371 Date: Jan. 21, 2009

(30) Foreign Application Priority Data
Apr. 19, 2006 (NL) 1031622
Jun. 29, 2006 (NL) 1032082

(51) Int. Cl. A47J 31/41

(52) U.S. Cl. 99/287

(57) ABSTRACT

A system for preparing a predetermined amount of beverage suitable for consumption, provided with an exchangeable holder, and an apparatus provided with a fluid dispensing device which is detachably connected to the holder for dispensing, under pressure, by means of the restriction, a jet of a first fluid, such as water, to the exchangeable holder, the exchangeable holder being provided with at least one storage space which is filled with a second fluid, such as a concentrate, and a first mixing chamber for mixing the first and the second fluid therein, the system further being provided with a narrow passage which is included in the fluid flow path between the restriction and the first mixing chamber for, on the one side, allowing the jet of the first fluid to pass from the restriction to the first mixing chamber, and, on the other side, for substantially preventing the first fluid, the second fluid and/or the beverage from proceeding from the first mixing chamber through the narrow passage in the direction of the restriction.

The invention relates to a system according to the preamble of claim 1. The invention also relates to an exchangeable holder for use in such a system. The invention further relates to an apparatus for use in such a system.

Such a system and such an exchangeable holder are known from WO 2006/043808.

In the known system, there is the possibility that, for instance during and/or after mixing in the first mixing chamber, from the first mixing chamber, an amount of first fluid, second fluid and/or beverage ends up on the restriction, through, for instance, splashing and/or capillary action, so that the restriction becomes contaminated. In an embodiment of the known system, the restriction is for instance included in the apparatus. As a result, the apparatus can become contaminated and is to be regularly cleaned so as to not form, for instance, a health risk.

In another embodiment of the known system, the restriction may be included in the exchangeable holder, so that the restriction that may be contaminated can be disposed of together with the holder. This has as drawback that the exchangeable holder must be provided with the restriction, which is a relatively expensive component as the size of the restriction is to precisely meet a predetermined size in order to generate the jet of the first fluid in an accurate manner. Hence, the exchangeable holder is relatively expensive, too expensive to serve as, for instance, a disposable holder.

The object of the invention is to provide is system with which, if desired, the above-mentioned drawbacks can be avoided and, moreover, other advantages can be realized.

Accordingly, the system according to the invention is characterized in that the system further is provided with a narrow passage which is included in the fluid flow path between the restriction and the first mixing chamber for, on the one side, allowing the jet of the first fluid to pass from the restriction to the first mixing chamber, and, on the other side, substantially preventing the first fluid, second fluid and/or the beverage from moving from the first mixing chamber through the narrow passage in the direction of the restriction.

As, presently, the narrow passage is included in the fluid flow path between the restriction of the first mixing chamber, the first fluid, the second fluid and/the beverage can be prevented from contaminating the restriction from the first mixing chamber. Hence, it is possible that the restriction, when this forms part of, for instance, the apparatus, needs not be cleaned, at least less often. Furthermore, the narrow passage can be provided with a less accurate size than the jet forming restriction so that, if desired, the narrow passage can form an inexpensive part of the exchangeable holder so that, if desired, the exchangeable holder can be provided as disposable holder.

It is preferred that the narrow passage has a cross section such that, in use, the narrow passage forms a free passage for the jet. Hence, the narrow passage is sufficiently great, so that the narrow passage does not hinder the jet. In this manner, mixing the first and second fluid in the first mixing chamber will hardly, if at all, be influenced by the presence of the narrow passage.

Preferably, the narrow passage has a cross section such that, in use, the jet substantially prevents the first fluid, the second fluid and/or the beverage from flowing from the first mixing chamber through the narrow passage to the restriction. In this manner, the narrow passage is sufficiently small to prevent the first fluid, the second fluid and/the beverage from ending up, upstream, through the narrow passage, “next to” the jet from the first mixing to the restriction.

In a special embodiment, a cross section of the narrow passage substantially corresponds to a cross section of the jet of the first fluid at the location of the narrow passage. Here however, the narrow passage is designed such that it does not, itself, form a jet of the first fluid, but allows the passage of the jet formed by the restriction. As a result, the narrow passage is provided which is sufficiently great and sufficiently small as described hereinabove. Here, a cross section of the narrow passage is preferably 1-2 times, more preferably 1.05-1.25 times a cross section of the jet of the first fluid at the location of the narrow passage.

Preferably, the narrow passage forms part of the exchangeable holder. Hence, if the passage channel is contaminated, with, for instance, the second fluid, the narrow passage can be detached from the apparatus together with the exchangeable holder, so that the narrow passage can be cleaned in a simple matter. As already stated, it is therefore also possible to provide the exchangeable holder in an inexpensive manner with the narrow passage and, if desired, the holder can then be designed as disposable holder, so that the narrow passage that may be contaminated can be disposed of together with the holder.

In a special embodiment, the narrow passage is formed by a passage restriction which is included in the fluid flow path between the restriction and the first mixing chamber. Hence, downstream of the restriction and upstream of the first mixing chamber, the passage restriction is provided by, on one side, allowing the jet of the first fluid to pass from the restriction to the first mixing chamber, and, on the other side, substantially preventing the first fluid, the second fluid and/or the beverage from proceeding from the first mixing chamber through the narrow passage in the direction of the restriction.

In a special embodiment, the narrow passage is formed by, at least the part of, a passage channel which is included in the fluid flow path between the restriction and the first mixing chamber. Hence, downstream of the restriction and upstream of the first mixing chamber, the passage channel is provided for, on the one side, allowing the jet of the first fluid to pass from the restriction to the first mixing chamber, and, on the other side, substantially preventing the first fluid, the second fluid and/or the beverage from ending up from the first mixing chamber, through the passage channel, at the restriction.

Preferably, the restriction forms part, at least partly of the fluid dispensing device. Hence, the jet forming restriction, which is an accurate (and, consequently, expensive) component, can be included in the apparatus, so that the exchangeable holder can be manufactured so as to be free of the accurate component so that, if desired, the exchangeable holder can be provided as disposable holder.

It is preferred that the passage channel forms part, at least partly, of the exchangeable holder. Hence, if the passage channel is contaminated by, for instance, the second fluid, the passage channel can be detached from the system together with the exchangeable holder so that the passage channel can be cleaned in a simple manner. If desired, the exchangeable holder can be provided as disposable holder, so that the contaminated passage channel can be disposed of.

Presently, the invention will be further elucidated on the basis of the drawing. In the drawing:

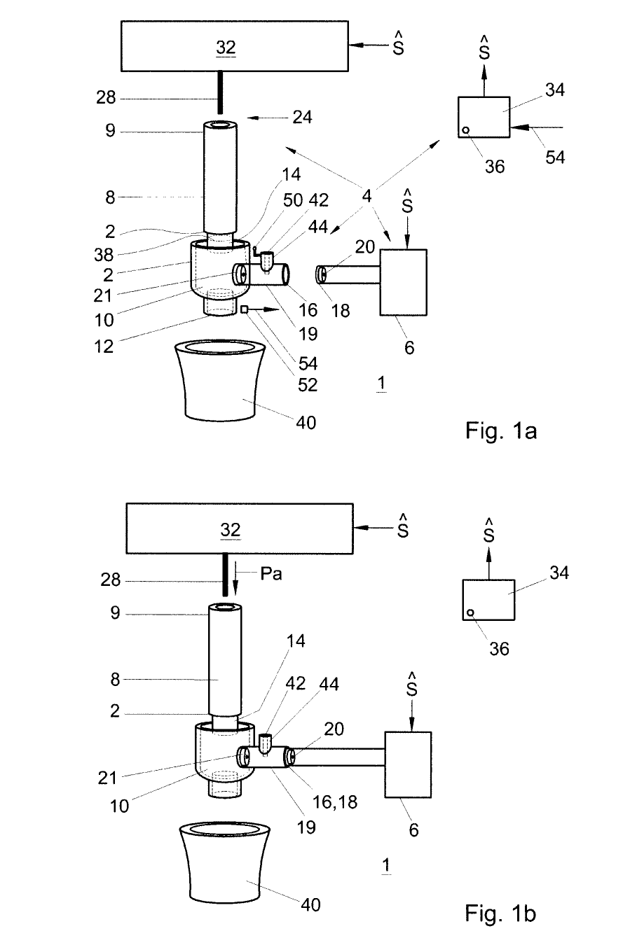

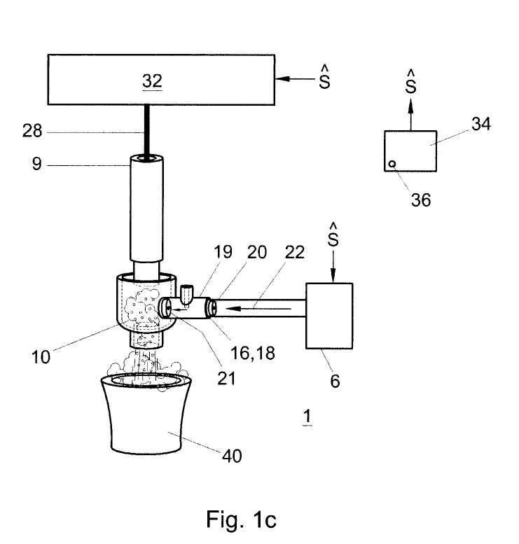

FIG. 1a shows a first embodiment of a system according to the invention;

FIG. 1b shows the system according to FIG. 1a in operative condition;

FIG. 1c shows the system according to FIG. 1a operative condition;

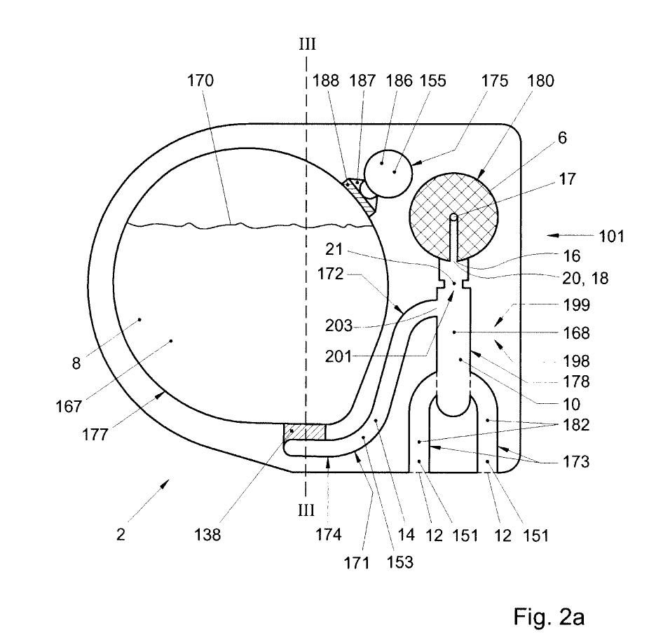

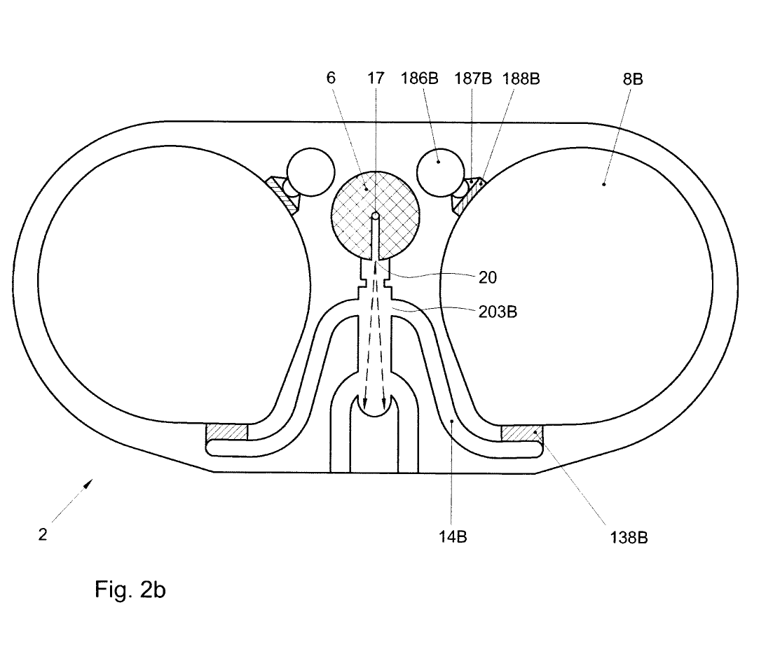

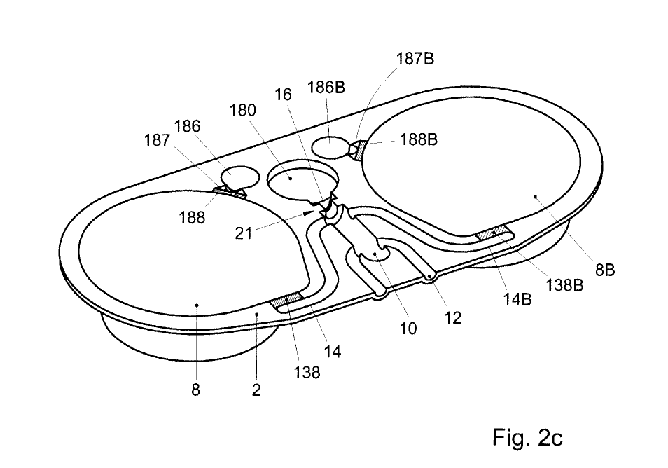

FIG. 2a shows a part of a second embodiment of a system according to the invention;

FIG. 2c shows a perspective view of the part of the third embodiment as shown in FIG. 2b;

FIG. 2b shows a part of a third embodiment of a system according to the invention;

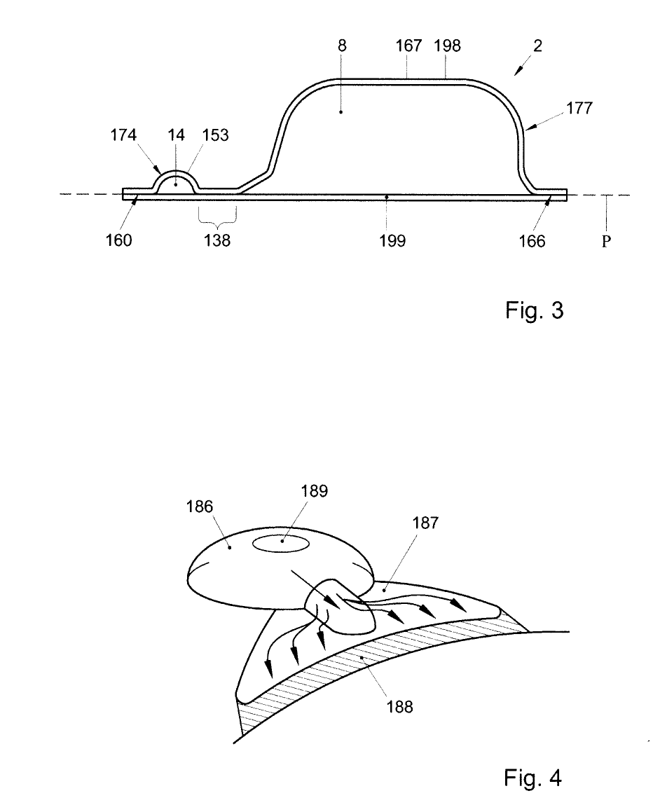

FIG. 3 shows a cross section, in a plane III shown in FIG. 2a, of the system of FIG. 2a;

FIG. 4 shows a view, in perspective, of a part of the holder shown in FIG. 2a;

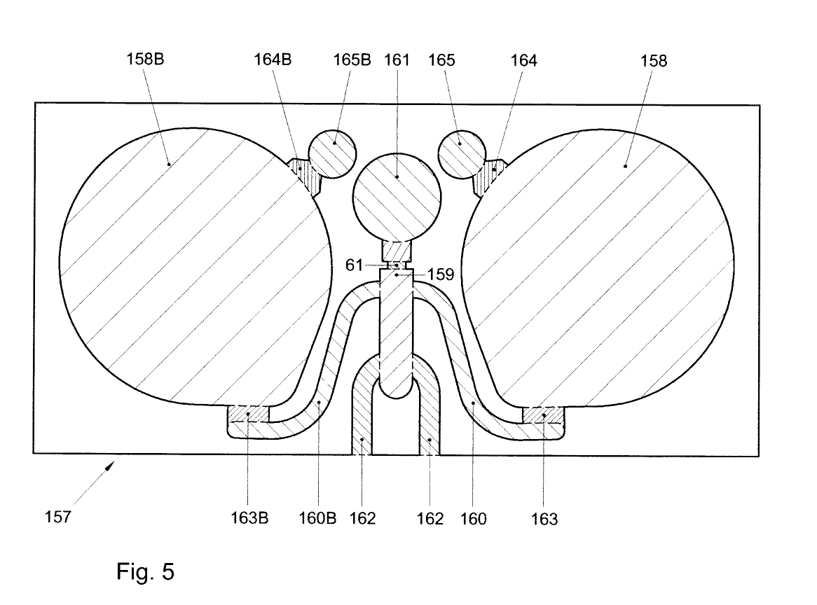

FIG. 5 shows a front view of a holder receiving portion of an apparatus of a system according to the invention; and

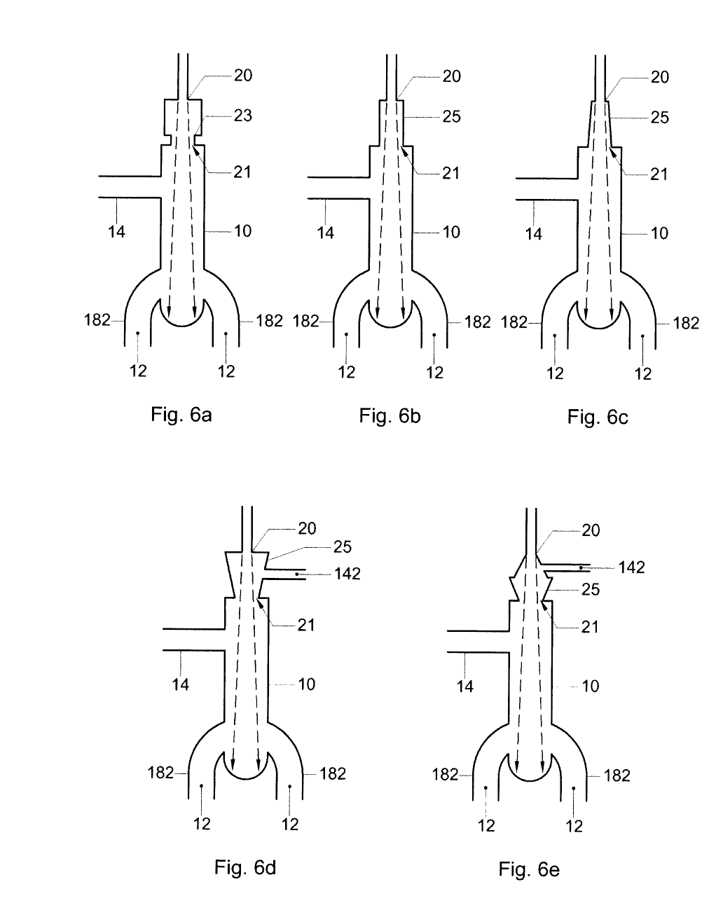

FIGS. 6a-6e show a first to a fifth exemplary embodiment of a part of a system according to the invention.

In FIG. 1, reference numeral 1 indicates a first embodiment of a system for preparing a predetermined amount of beverage suitable for consumption. The system (see FIG. 1a) is provided with exchangeable holder 2 and an apparatus 4 which is provided with, inter alia, a fluid dispensing device 6 which is designed for dispensing, under pressure, at least one amount of at least a first fluid such as a liquid and/or a gas, more particularly such as water and/or steam. In this example, in use, the fluid dispensing device 6 dispenses water.

The exchangeable holder 2 is provided with at least one storage space 8 which is filled with a second fluid such as a beverage, a concentrate or a powder. In this example, a concentrate for preparing coffee is involved. The holder 2 is further provided with at least a first mixing chamber 10 and at least one outflow opening 12 which is in fluid communication or can be brought in fluid communication with the first chamber 10. The holder 2 is further provided with a fluid communication 14 between the storage space 8 and the first mixing chamber 10. The holder 2 is further provided with at least one inlet opening 16 which is detachably connected to the outlet opening 18 of the fluid dispensing device 6. In FIG. 1a, the inlet opening 16 is not yet connected to the outlet opening 18. This is, however, the case in FIG. 1b. In this example, the inlet opening 16 in FIG. 1a is not yet sealed off by a closure that can be removed, such as a removable seal. This also holds for the outflow opening 12. In use, both removable seals are removed whereupon the outlet opening 18 can be connected to the inlet opening 16 as shown in FIG. 1b.

In this example, the system is further provided with a restriction 20 which is included in a fluid flow path 22 which extends via the outlet opening 18 of the fluid dispensing device 6 and the inlet opening 16 of the exchangeable holder 2 from the fluid dispensing device 6 to the first mixing chamber 10 for generating, with the restriction 20, a jet of the first fluid which is supplied to the first mixing chamber. The restriction 20 can comprise, for instance, a local constriction in the fluid flow path, or a different construction for generating the jet of the first fluid. In this example, the restriction 20 is included upstream of the outlet opening 18 in the fluid flow path 22. In this example, the restriction 20 therefore forms part of the fluid dispensing device 6 of the apparatus 4.

In this example, the system is further provided with a supply channel 19 which is included in the fluid flow path 22 between the restriction 20 and the first mixing chamber 10. In this example, the supply channel 19 is included downstream of the inlet opening 16 in the fluid flow path 22. In this example, the supply channel 19 therefore forms part of the exchangeable holder 2.

In this example, the system is further provided with a narrow passage 21 which is included in the fluid flow path 22 between the restriction 20 and the first mixing chamber 10. The narrow passage 21 allows, on the one side, the jet of the first fluid to pass from the restriction 20 to the first mixing chamber 10, and, on the other side, substantially prevents the first fluid, the second fluid and/or the beverage from proceeding from the first mixing chamber 10 through the narrow passage 21 in the direction of the restriction 20. In this example, the narrow passage 21 is included downstream of the inlet opening 16 in the fluid flow path 22. In this example, the narrow passage 21 therefore forms part of the exchangeable holder 2.

The storage space 8 forms at least a part of a dosing device 24 as will be further set forth hereinafter. In this example, this dosing device 24 is further provided with a needle 28 which, in use, is pierced through a wall of the storage space 8 for supplying a third fluid to the second fluid in the storage space 8 for dispensing the second fluid in a dosed manner to the first mixing chamber 10. In this example, the dosing device 24 is further provided with a fluid dispensing unit 32 which is connected to the needle. The fluid dispensing unit 32 and the needle 28 form part of the apparatus 4. In this example, the fluid dispensing unit 32 is detachably connectable, at least via the needle 28, to the holder 2.

The apparatus 4 is further also provided with a control device 34 for controlling the fluid dispensing device 6 and the fluid dispensing unit 32. To control the fluid dispensing device 6 and the fluid dispensing unit 32, the control device 34 generates control signals ŝ which are supplied to the fluid dispensing device 6 and the fluid dispensing unit 32. In this example, the control device 34 is designed for controlling the fluid dispensing device 6 and the fluid dispensing unit 32 independently of each other.

The apparatus can further be provided with a code reading unit 52 which is connected by means of a signal wire 54 to the control unit 34. The exchangeable holder can be provided with, for instance, a readable code in the form of, for instance, a bar code or a code stored in a responder known per se. Via the code reading unit 52, the control device 34 reads out a code which indicates, for example but not exclusively, whether or not air is to be supplied to the system, which temperature and/or pressure the first fluid is to have, how much first fluid is to be supplied and/or at what pressure and/or at what speed the second fluid is to be supplied to the first mixing chamber. This code may depend on the type of second fluid stored in the holder 2.

The system 1 described heretofore works as follows. For the purpose of preparing a predetermined amount of beverage suitable for consumption, the exchangeable holder 2 is placed in the apparatus 4. Here, the storage space 8 of the exchangeable holder 2 is placed under the needle 28. Also, as shown in FIG. 1b, the outlet opening 18 is connected to the inlet opening 16. The apparatus is now ready for use. By pushing, for instance, a button 36 of the control device 34, the control device provides for the fluid dispensing device 32 to move the needle 28 in the direction of the arrow Pa. The result thereof is that the needle 28 is pierced through a wall of the storage space 8 and the third fluid is supplied, under pressure, to the second fluid in the storage space. Consequently, the third fluid will apply a pressure and/or force to the second fluid. Hence, in this example, the pressure in the storage space 8 will increase. Here, the fluid communication 14 can further be provided with, for instance, a seal 38, in the form of, for instance, a breakable skin 38 which tears open as a result of the increase of the pressure in the storage space 8 resulting from the supply of the third fluid. As a result, in this example, the coffee concentrate will flow in a dosed manner from the storage space 8 via the fluid communication 14 to the first mixing chamber 10. Simultaneously, the control device 34 ensures that the fluid dispensing device 6 is activated. This results in that the fluid dispensing device 6 starts dispensing the first fluid under pressure, in this example water. In this example, this water is hot water with a temperature of, for instance, 80-98° C. This hot water flows via the fluid flow path 22 to the restriction 20. Having arrived at the restriction 20, a jet of the hot water is generated by means of the restriction 20. This jet spouts via the outlet opening 18 and the inlet opening 16, through the narrow passage 21, into the first mixing chamber 10. In the first mixing chamber 10, the hot water will start mixing well with the concentrate. Here, the flow rate at which the concentrate is supplied to the first mixing chamber 10 is regulated by the control device 34, through control of the fluid dispensing unit 32. The flow rate at which the hot water is supplied to the first mixing chamber 10 is further also regulated by the control device 34 through control of the fluid dispensing device 6. In the first mixing chamber, as a result of the jet, the concentrate will mix well with the hot water, so that the beverage is formed. This beverage can then leave the outflow opening 12 and be captured in, for instance, a mug 40.

As, with the system 1 according to the invention, both the dosing of the concentrate over time and the dosing of the hot water over time can be regulated well, it can be ensured that the concentration of the amount of concentrate in the beverage can be accurately determined. Furthermore, it can be ensured that the beverage which, during its preparation, leaves the outflow opening 12, is of constant quality, i.e., the concentration of the concentrate in the beverage that is dispensed can be kept constant during dispensing, if desired. The fact is that in this example, the flow rate of the water and the flow rate of the concentrate supplied to the first mixing chamber 10 can each, if desired, be controlled independently of each other. Therefore, it holds in this example, that the system 1 is designed such that the fluid dispensing device 6 and the dosing device 24 can supply, independently of each other, the first fluid and the second fluid, respectively, to the first mixing chamber 10. This entails that the size of the flow rate of the first fluid and the period during which the first fluid is dispensed are independent (in this example through control of the control device) of the size of the flow rate of the second fluid and the period during which the second flow rate is dispensed.

It further holds in this example, that the dosing device 24 is a controllable and active dosing device for supplying the second fluid to the first mixing chamber by applying an increased pressure or force to the second fluid. Herein, an active dosing device is understood to mean that the second fluid flows through the fluid communication from the storage space to the first mixing chamber as a result of an excess pressure or force applied on the side of the storage space.

In the example, the system 1 is further provided with an air inlet opening 42. The air inlet opening 42 ensures that air is supplied to the first mixing chamber 10 so that, in use, air is whipped into the beverage for obtaining a beverage with a fine-bubble froth layer. Thus, a café crème can be obtained. In this example, the air inlet opening 42 is in fluid communication with the first mixing chamber 10 downstream of the restriction 20. In this example, the air inlet opening 42 terminates, via a fluid communication 44, in the fluid flow path 22, in this example in the supply channel 19, in this example upstream of the narrow passage 21. It therefore holds in this example, that the air inlet opening 42 as well as the supply channel 19 each form part of the apparatus 4. This is, however, not required. It will be clear that the air inlet opening 42 and/or the supply channel 19 can form part of the exchangeable holder 2.

After the beverage, in this example coffee with a fine-bubble froth layer, has been prepared, the control device 34 stops the fluid dispensing device 6. The control device 34 also ensures that the third fluid is no longer supplied to the second fluid in the storage space, and that the needle 28 is retracted from the respective wall of the storage space 8, i.e., in a direction opposite that of the arrow Pa. Here, it may be such that the control device 34 first provides that the dispensing of the second fluid to the first mixing chamber is stopped and that after that, the supply of the first fluid (in this example, water) is stopped. Thus, the risk of the second fluid contaminating, for instance, the restriction 20 is further reduced.

FIG. 1c shows a situation where the needle 28 is pierced through a wall of the storage space 8 and the third fluid is supplied under pressure to the second fluid in the storage space 8. The situation shown occurs at the moment when the control device 34 will stop the supply of hot water to the first mixing chamber 10, will no longer effect the supply of the third fluid to the second fluid in the storage space 8, and will effect the retraction of the needle 28 from the respective wall of the storage space 8 so that, thereupon, the holder 2 can be taken from the apparatus 4 again.

After this, a user can remove the exchangeable holder 2 and, if a new amount of beverage is to be prepared, place a new exchangeable holder in the apparatus 4. The new exchangeable holder can be provided with an entirely different type of second fluid such as, for instance, a milk concentrate. When, with the aid of the new exchangeable holder, milk is prepared in a manner comparable to that as described for the preparation of coffee based on coffee concentrate, in the prepared milk, no trace will be found of the previously prepared type of beverage. The fact is that the first mixing chamber 10 forms part of the exchangeable holder and when a new exchangeable holder is placed in the apparatus 4, also, an entirely new and, hence, clean first mixing chamber is placed in the holder, and the narrow passage 21 will further substantially prevent contamination of the restriction 20 with the previously prepared type of beverage. Therefore, contamination cannot be involved.

In the example of FIGS. 1a-1c, the dosing device 24 is designed for supplying the third fluid under pressure to the second fluid in the storage space 8 for dispensing the second fluid in a dosed manner to the first mixing chamber 10. It will be clear that in addition or as an alternative, the dosing device 24 can be provided with a compressing unit for compressing the storage space 8 for dispensing the second fluid to the first mixing chamber 10 in a dosed manner, as described in, for instance, WO 2006/04380.

In the example of FIGS. 1a-1c, the jet of the first fluid spouts into the first mixing chamber 10. It is possible that here, the jet impacts on an inside wall of the first mixing chamber 10, while swirls are formed in the first mixing chamber 10, resulting in that the concentrate, the first fluid and, optionally, air are mixed together. It is also possible that the jet impacts on a jet impact element in the first mixing chamber 10. Upon impact of the jet on the jet impact element, the liquid is atomized, so that air can be whipped in well.

FIGS. 6a-6e schematically show exemplary embodiments of a part of the system 1.

FIG. 6a schematically shows a first exemplary embodiment of a part of the system 1. In this example, the narrow passage 21 is formed by a passage restriction 23 which is included in the fluid flow path between the restriction 20 and the first mixing chamber 10.

FIG. 6a schematically indicates, with interrupted arrows, the jet of the first fluid formed by the restriction 20. The jet can proceed parallel from the restriction 20, can converge or diverge, depending on, for instance, the shape of the restriction 20. In this example, the jet is represented in a slightly diverging manner.

Preferably, the narrow passage 21 has a cross section such that, in use, the narrow passage 21 forms a free passage for the jet. To that end, it is preferred that the narrow passage is designed to be sufficiently great. The narrow passage is sufficiently great if the jet is hardly, if at all, hindered by the narrow passage 21, so that mixing of the first and second fluid in the first mixing chamber 10 is hardly, if at all, disturbed by the narrow passage 21.

When the jet spouts through the narrow passage, the first fluid, the second fluid or beverage will not be able proceed from the first mixing chamber 10, against the flow of the jet, to the restriction 20 at the location of the jet. In principle, the first fluid, second fluid or beverage can proceed next to the jet from the first mixing chamber 10 to the restriction.

Preferably, the narrow passage 21 has a cross section such that, in use, the jet substantially prevents the first fluid, the second fluid and/or the beverage from flowing from the first mixing chamber 10 through the narrow passage 21 to the restriction 20. To that end, the narrow passage 21 is preferably of sufficiently small design. The narrow passage 21 is sufficiently small if, next to the jet, no, at least little, fluid can flow from the first mixing chamber 10 through the narrow passage 21 to the restriction 20.

The narrow passage 21 is for instance sufficiently great and sufficiently small, as described hereinabove, if the cross section of the narrow passage 21 substantially corresponds to the cross section of the jet of the first fluid at the location of the narrow passage. In a practical embodiment, the cross section of the narrow passage 21 is preferably 1-2 times, more preferably 1.05-1.25 times the cross section of the jet of the first fluid at the location of the narrow passage.

FIG. 6b schematically shows a second exemplary embodiment of a part of the system 1. In this example, the narrow passage 21 is formed by a passage channel 25 which is included in the fluid flow path between the restriction 20 and the first mixing chamber 10. With the diverging jet, adjacent the downstream end of the passage channel 25, the cross section of the jet will correspond most to the cross section of the passage channel 25. Hence, the passage channel 25 has, in relation to the diverging bundle, a narrowest point adjacent the downstream end of the passage channel. When compared to the passage restriction 23, it is possible, when using the passage channel 25, to provide, over a greater length of the jet, a smaller distance between the jet and a wall of the narrow passage 21. Hence, the risk of fluid flowing from the first mixing chamber through the narrow passage 21 to the restriction 20 will be further reduced.

FIG. 6c schematically shows a third exemplary embodiment of a part of the system 1. In this example, the narrow passage 21 is formed by the passage channel 25, wherein at least one transverse dimension, such as a width, diameter or cross section of the passage channel 25 increases in the direction from the restriction 20 to the first mixing chamber 10. To that end, one shape of the passage channel may comprise a wedge-shape, cone-shape or half-cone shape. As a result, it is for instance possible, if desired, that with the diverging jet, the distance between the jet and a wall of the narrow passage 21 is substantially constant.

FIG. 6d schematically shows a fourth exemplary embodiment of a part of the system 1. In this example, the narrow passage 21 is formed by the passage channel 25, while at least one transverse dimension of the passage channel 25 decreases in the direction from the restriction 20 to the first mixing chamber 10. To that end, one shape of the passage channel 25 may comprise a wedge-shape, cone-shape of half-cone shape. Thus, in a simple manner, a narrow passage 21 is provided having a narrowest point at a distance from the restriction 20. Furthermore, in this manner, upstream of the narrowest point of the narrow passage 21, a space is created adjacent and/or around the jet. In FIG. 6d, the system 1 is also provided with an air supply 142 for supplying air to the first fluid. In FIG. 6d, the air supply 142 terminates in the fluid flow path, upstream of the narrowest point of the narrow passage 21. As the space is created upstream of the narrowest point of the narrow passage, the air can be supplied to the first fluid in an efficient manner.

FIG. 6e schematically shows a fifth exemplary embodiment of a part of the system 1. In this example, the narrow passage 21 is formed by the passage channel 25. In FIG. 6e, the passage channel 25 comprises a first part with a transverse dimension increasing in the direction from the restriction 20 to the first mixing chamber 10, and a second part with a transverse dimension decreasing in the direction from the restriction 20 to the first mixing chamber 10. In FIG. 6e, the system 1 is also provided with an air supply 142 for supplying air to the first fluid. In FIG. 6e, the air supply 142 terminates in the fluid flow path, upstream of the narrowest point of the narrow passage 21. It will be clear that the exemplary embodiments shown in FIGS. 6a-6c can also be provided with the air supply 142.

As shown in FIGS. 1a-1c, the narrow passage 21 can form part of the exchangeable holder 2. This also holds for the exemplary embodiments shown in FIGS. 6a-6e. Thus, if the narrow passage 21 is contaminated with, for instance, the second fluid, the narrow passage 21 can be detached, together with the exchangeable holder 2, from the apparatus 4, so that the narrow passage 21 can be cleaned in a simple manner. As already stated, it is therefore also possible to provide the exchangeable holder 2 in an inexpensive manner with the narrow passage 21 and, if desired, the holder 2 can then be designed as disposable holder, so that the narrow passage that may be contaminated can be disposed of together with the holder. However, if desired, the narrow passage 21 can also form part of the apparatus 4.

It will be clear that thus, the passage restriction 23 and/or the passage channel 25 can form part of the exchangeable holder 2. Here, the passage channel can from part of the exchangeable holder completely, but also in part, for instance a part of the passage channel which is in contact with a wall of the first mixing chamber 10.

As shown in FIGS. 1a-1c, the restriction 20 can form part, wholly or partially, of the fluid dispensing device. This also holds for the exemplary embodiments shown in FIGS. 6a-6e. Hence, the jet forming restriction, which is an accurate (and, consequently, expensive) component, is included in the apparatus 4, so that the exchangeable holder 2 can be manufactured so as to be free of the accurate component so that, if desired, the exchangeable holder can be provided as disposable holder. However, if desired, the restriction can also form part of the exchangeable holder.

In the examples, the first mixing chamber 10 is placed at a distance from the restriction 20 in that spacers are included between the first mixing chamber and the restriction. The spacers can be formed by, for instance, the passage channel 25 and/or the supply channel 19. If the jet-forming restriction, at least a part of the restriction that becomes contaminated as little as possible, is included in the apparatus, and the spacers are, at least partly, included in the exchangeable holder, it is possible to reduce the risk of contamination of at least this part of the restriction by detaching this part of the restriction from the holder directly after preparation of the beverage. In this manner, any contamination (for instance first fluid, second fluid and/or beverage) that may be present in the spacers can no longer proceed through, for instance, capillary action to that part of the restriction.

FIG. 2a shows a part of a second embodiment of a system according to the invention. In the system 1 shown in FIG. 2a, a cross section of at least a part of the fluid dispensing device 6 is represented in crossed hatchings. The fluid dispensing device comprises a fluid supply channel 17 for supplying the first fluid to the restriction 20. The restriction 20 generates a jet of the first fluid. In this example, the restriction 20 also forms the outflow opening 18 of the fluid dispensing device 6.

The system 1 is further provided with a narrow passage 21 which is included in the fluid flow path between the restriction 20 and the first mixing chamber 10. In this example, the narrow passage 21 is included in the exchangeable holder 2. On the one side, the narrow passage 21 allows the jet of the first fluid to pass from the restriction 20 to the first mixing chamber 10, and, on the other side, substantially prevents the first fluid, the second fluid and/or the beverage from proceeding from the first mixing chamber 10, through the narrow passage 21 in the direction of the restriction 20. From the first mixing chamber 10, via an outflow channel 182 forming a fluid communication between the first mixing chamber 10 and the outflow opening 12, the beverage can leave the outflow opening 12.

In the example of FIGS. 2a and 3, the holder 2 comprises a first holder part 198 and a second holder part 199 (see FIG. 3). FIG. 2a is a top plan view to the side of the holder 2 where the first holder part 198 is situated. FIG. 3 is a cross section along the line III-III in FIG. 2a.

In this example, the storage space 8 and the first mixing chamber 10 are formed by the first holder part 198 and the second holder part 199. In this example, the storage space 8 is bounded, at least substantially, by the first holder part 198 and the second holder part 199. In this example, the first mixing chamber 10 is bounded, at least substantially, by the first holder part 198 and the second holder part 199.

The second holder part 199 is of substantially flat design. This means that the second holder part extends substantially in a (virtual) plane P. The first holder part 198 comprises a substantially flat contacting surface 166 extending substantially parallel to the plane P. The second holder part 199 abuts against the contacting surface 166 of the first holder part 198. In this example, the second holder part 199 is connected to the first holder part 198 at the contacting surface 166, by means of, for instance, gluing, welding and/or sealing.

The storage space 8 comprises a wall 167 which is offset relative to the contacting surface 166. The first mixing chamber 10 also comprises a wall 168 which is offset relative to the contacting surface 166. The walls 167, 168 each form part of the first holder part 198. In this example, the walls 167, 168 are both offset to the same side relative to the contacting surface, in a direction away from the second holder part 199. This offers the advantage that the first holder part 198 can be manufactured in a simple manner, and that the second holder part 199 can be connected to the contacting surface 166 in a simple manner. In the example of FIGS. 2a and 3, the first holder part 198 is substantially plate-shaped. The wall 167 forms part of a protrusion 177 of the plate-shaped first holder part 198 which bounds the storage space 8, together with, at least a part of, the second holder part 199. The wall 168 forms part of a protrusion 178 of the plate-shaped first holder part 198 which bounds the first mixing chamber 10, together with, at least a part of, the second holder part 199.

Hereinabove, with reference to FIG. 1, it is set forth that the needle 28 is pierced through a wall of the storage space 8 and the third fluid is supplied, under pressure, to the second fluid in the storage space. With the exchangeable holder according to example of FIGS. 2a and 3, the needle 28 is not directly pierced into the storage space 8, but in a fluid inlet chamber 186 which is in fluid communication or can be brought in fluid communication with the storage space 8. The fluid inlet chamber 186 is also shown in FIG. 4.

In this example, the fluid inlet chamber 186 communicates, via a zone 187 in which the first holder part 198 is not attached to the second holder part 199, with a fluid communication seal 188 for bringing a fluid communication between the fluid inlet chamber 186 and the storage space 8 into operation through removal of the sealing action of the fluid communication seal 188. In the example, the fluid communication seal 188 is a peel seal 188, i.e., a weakened part with respect to the sealing attachment between, on the one side, material from which the first holder part is manufactured and, on the other side, material of the second holder part. In the manufacturing process of the exchangeable holder, the weakened location can be realized in a simple manner, for instance if the first and second holder part are sealingly interconnected by means of heating and compressing of the first and second holder part, by locally reducing the heating temperature and/or the compression pressure, and/or by locally utilizing a coating, wax or the like between the first and second holder part. The peel seal is a compact and inexpensively manufactured solution for bringing the fluid communication into operation through removal of the sealing action of the peel seal.

In this example, the peel seal 188 adjoins the storage space 8. The needle 28 (see FIG. 1) of the dosing device 24 can be pierced through a wall part 189 (see FIG. 4) of the fluid inlet chamber 186. In this manner, the third fluid can be supplied to the fluid inlet chamber 186, whereupon the third fluid can be supplied under pressure via the zone 187 and the peel seal 188 to the storage space 8. In FIG. 4, the fluid direction of the third fluid is indicated with the aid of arrows. In this example, with the aid of the zone 187, a relatively large effective surface of the peel seal 188 is obtained, on which surface the pressure of the third fluid can act for opening the peel seal 188.

In the example of FIGS. 2a and 3, the outflow channels 182, the fluid connection 14, and the fluid inlet chamber 186 each comprise a wall 151, 153, 155, offset relative to the contacting surface 166. In this example, the walls 151, 153, 155, 167, 168 are all offset to the same side relative to the contacting surface, in a direction away from the second holder part 199. In this example, the walls 151, 153, 155 each form part of a protrusion 173, 174, 175 of the plate-shaped first holder part 198 which, together with at least a part of the second holder part 199, bound the outflow channels 182, the fluid connection 14, and the inlet opening 186, respectively. The narrow passage 21 can also comprise a wall, for instance a protrusion, offset relative to the contacting surface 166. It is also possible that the narrow passage is formed by an insert, such as, for instance, an injection molded part or a tube or hose whose inside diameter forms the narrow passage, which is placed in, for instance, a recess or protrusion of the second holder part.

The first holder part 198, comprising the protrusions 177 and 178 which bound the storage space 8 and the first mixing chamber 10, respectively, can be advantageously manufactured by means of vacuum formation, thermo formation, pressing, deep drawing and/or deep pressing. In this manner, it is possible to inexpensively and rapidly mass-produce the first holder part 198, if desired. Here, the first holder part is manufactured from, for instance, plastic.

In the example of FIGS. 2a and 3, the second holder part 199 is designed as a sheet-shaped wall, which, in this example, is connected to the contacting surface 166 of the first holder part 198. To that end, the second holder part is designed as, for instance, a foil of, for instance, plastic and/or metal.

In a special embodiment, the exchangeable holder 2 is designed as a blister pack, while the first holder part 198 is provided with blister chambers (designed here as the protrusions 173, 174, 175, 177, 178) and the second holder part 199 forms a covering of the blister chambers. In the example of FIGS. 2a and 3, the storage space 8, the first mixing chamber 10, the outflow channels 182, the fluid communication 14, and the fluid inlet chamber 186 are each formed by one of the blister chambers. In this example, the blister chambers are in fluid communication with each other or can be brought into mutual fluid communication with each other.

In the example of FIGS. 2a and 3, the exchangeable holder 2 is further provided with the fluid communication seal 138 for bringing the fluid communication 14 into operation through removal of the sealing action of the fluid communication seal 138. In the example shown, the fluid communication seal 138 is a peel seal 138, similar to, for instance, the peel seal 188.

In this example, the fluid communication 14 is channel which is not straight in the longitudinal direction of the channel. In FIG. 2a for instance, it is shown that the fluid communication 14, in longitudinal direction of the channel, has a first curvature 171 in a plane parallel to the covering 199.

The exchangeable holder 2 is further provided with a chamber 180 which communicates, via the inlet opening 16, with the first mixing chamber 10. Via this chamber 180, the outlet opening 18 of the fluid dispensing device 6 can be connected to the inlet opening 16. As already stated, in FIG. 2a, the cross section of at least a part of the fluid dispensing device 6 is represented in crossed hatchings. The fluid dispensing device 6 comprises the fluid supply channel 17 for supplying the first fluid to the restriction 20. In this example, a part of the fluid dispensing device 6 that comprises the restriction 20, is included in the chamber 180. In use, the restriction 20 generates the jet of the first fluid. In this example, the restriction also forms the outlet opening 18 of the fluid dispensing device 6. The chamber 180 can also be bounded, at least partly, by a wall which is offset relative to the contacting surface. Here, the chamber 180 can be formed, at least partly, by a protrusion of the first holder part 198, for instance a blister chamber of the first holder part. The first mixing chamber comprises a first entrance opening 201 which is in fluid communication with the inlet opening 16 for supplying the first fluid to the first mixing chamber. The first mixing chamber further comprises a second entrance opening 203 into which the fluid communication 14 terminates for supplying the second fluid through the first mixing chamber 10. The first entrance opening 201 and the second entrance opening 203 are separated from each other.

Reference is now made to FIG. 5. In FIG. 5 is shown a holder receiving portion 157 of the apparatus. The holder receiving portion 157 is designed for detachably receiving the exchangeable holder 2 for preparing a beverage suitable for consumption. In this example, the holder receiving portion 157 is provided with protrusion receiving recesses for receiving protrusions of the holder 2. For instance, a first protrusion receiving recess 158 is designed for receiving the protrusion 177 which bounds the storage space 8, a second protrusion receiving recess 159 for receiving the protrusion 178 which bounds the first mixing chamber 10, and a third protrusion receiving recess 160 for receiving the protrusion 174 which bounds the fluid communication 14. These protrusion receiving recesses 158, 159, 160 have contours, viewed in cross sections through a plane parallel to the first holder part 199 of the holder 2 received in the holder receiving portion 157, which correspond at least partly to contours of these protrusions which bound the storage space 8, the first mixing chamber 10 and the fluid communication 14.

Further, the holder receiving portion 157 is provided with further recesses, i.e., a recess 161 for receiving the chamber 180, two recesses 162 for receiving the outflow channels 182, a recess 163 for receiving the peel seal 138 and having it detach under pressure, a recess 164 for receiving the zone 187 and the peel seal 188 and having them detach under pressure, a recess 165 for receiving the fluid inlet chamber 186, and a recess 61 for a protrusion of the holder 2 corresponding to the narrow passage 21.

It is noted that in FIG. 5, a recess is deeper according as the hatching lines represented in this recess are closer together. For instance, in the example of FIG. 5, the first protrusion receiving recess 158 (intended for the storage space 8) is deeper than the second protrusion receiving recess 159 (intended for the first mixing chamber 10) which, in turn, is deeper than the third protrusion receiving recess 160 (intended for the fluid communication 14). However, other mutual depth proportions for the different recesses are also possible. It is further noted that the view shown in FIG. 5 is a view in the direction of increasing depth of the recesses.

For preparing a beverage suitable for consumption, the holder 2 shown in FIG. 2a can be placed by a user in the holder receiving portion 157 of the apparatus 4 shown in FIG. 5. In placed condition, the holder 102 is situated substantially at the center part and right hand part of the holder receiving portion 157 shown in FIG. 5. Thus, the preparation of the beverage can take place as described hereinabove with reference to FIGS. 1a-1c.

In placed condition, the holder 2 is, in operation, preferably in a position such that the outflow opening(s) 12 are situated on a side facing downwards of the first mixing chamber 10. Here, the holder 2 can, for instance, be placed such that the first holder part 199 of the blister pack 2 is placed vertically. When placing in the holder receiving portion 157, the holder 2 may still be placed with the first holder part 199 of the holder 2 horizontally, and then, for bringing the system in the operative condition, the holder receiving portion 157 can be turned such that the exchangeable holder 2 is placed vertically.

In FIG. 2a, reference numeral 170 indicates the level of the second fluid in the storage space 8 when the holder 2 is placed and is in operative condition. According as, in operation, more and more of the second fluid is supplied to the first mixing chamber, the level 170 drops more and more. In order to optimally empty the storage space 8, it is advantageous when, in operation, the location where the second fluid flows from the storage space 8 is situated as far downwards as possible. In the example shown, the peel seal 138 is therefore situated at a position as much downwards as possible relative to the storage space 8.

The above-mentioned correspondence of the contours of the protrusion receiving recesses to the contours of the protrusions offers the advantage that in operation, the holder receiving portion 157 contributes to the wall parts of the first holder part being held in place when pressure is applied to these wall parts. This being the case, it is advantageous when parts of the contours of the protrusion receiving recess 160 of the holder receiving portion 157 correspond at least partly to parts of the contours of the first curvature 171 of the fluid communication 14. In this respect, it is further advantageous when parts of the contours of the protrusion receiving recess 160 of the holder receiving portion 157 correspond at least partly to parts of the contours of the second curvature 172 of the fluid communication 14, so that the protrusion receiving recess 160 proceeds at least partly in an S-shape.

Presently, reference is made to FIG. 2b, in which a holder 2 is shown. The difference from the holder shown in FIG. 2a is that the holder shown in FIG. 2b comprises a second storage space 8B, similar to the storage space 8, and a second fluid communication 14B, similar to the fluid communication 14 and a third entrance opening 203B, similar to the second entrance opening 203. The third entrance opening is at a distance from the first and second entrance opening which are also at a mutual distance from each other. In the two storage spaces 8 and 8B, mutually different second fluids may be stored, for instance coffee concentrate in one, and a milk concentrate in the other. The holder 2 also comprises a second fluid inlet chamber 186B, a second zone 187B, a second peel seal 188B, and a second peel seal 138B, each similar to the fluid inlet chamber 186, the zone 187, the peel seal 188 and the peel seal 138, respectively. It is noted that in FIG. 2b, for the sake of clarity of FIG. 2b, the reference numerals included in FIG. 2a are not included again.

The holder 2 having the two storage spaces 8 and 8B can be used in a system which is provided with a dosing device which is designed for dispensing the second fluids in a dosed manner from the two different storage spaces to the first mixing chamber 10. With respect to the example shown in FIG. 1, the dosing device can comprise, to that end, in addition to the needle 28, for instance a second needle, while the second needle can then be introduced into the second chamber 186B.

For preparing a beverage suitable for consumption, also, the holder 2 can be placed on the holder receiving portion 157 of the apparatus 4, shown in FIG. 5. The holder receiving portion 157 shown in FIG. 5 is therefore suitable for the holder 2 shown in FIG. 2a, as well as for the holder 2 shown in FIG. 2b.

Preferably, the two storage spaces 8 and 8B are situated on opposite sides of the first mixing chamber 110 and, also, the two fluid communications 14 and 14B are on opposite sides of the first mixing chamber 10, as is the case in the example shown in FIG. 2b. In this manner, the compactness of the holder 2 is realized, while then, the associated holder 2 having only one storage space 8 but still fitting in the same holder receiving portion 157, is also compact.

As stated, the fluid communication 14 is a channel having, in longitudinal direction of the channel, a first curvature 171 in a plane parallel to the first holder part 199. It is further advantageous when the channel has a second curvature in this longitudinal direction in the plane mentioned, indicated with reference numeral 172 in FIG. 2, which second curvature is preferably the opposite of the first curvature so that the channel has a S-shaped portion. The first and/or second curvature 171, 172 contribute to an increased flow resistance of the fluid communication 14. In addition, with the aid of the second curvature 172, the fluid communication 14 can be designed such that a favourable inflow of the second fluid into the first mixing chamber 110 can be realized. Thus, it can for instance be ensured, with the aid of the second curvature 172, that the fluid communication 14 links up at a more or less locally right angle to the first mixing chamber 10, so that the second fluid, upon entering the first mixing chamber 10, on the one side, does not tend too much towards the direction of the inlet opening 16, and, on the other side, does not tend too much towards the outflow openings 12.

In order to avoid that the second fluid does not obtain sufficient opportunity to mix with the first fluid in the first mixing chamber 10, it is advantageous that the location where the fluid communication 14 links up with the first mixing chamber is not too close to the location where the outflow channels 182 link up with the first mixing chamber 10. When the first mixing chamber 10 is provided with an air inlet opening for supplying air to the first mixing chamber, so that, in use, air is whipped into the beverage for obtaining a beverage with a fine-bubbled froth layer, it is advantageous that the location where the fluid communication 14 links up with the first mixing chamber is not too close to the air inlet opening, as otherwise, a favourable supply of air can be disturbed. Through the use of the first curvature 171 and the second curvature 172, for these and other reasons, desired connections of the fluid communication 114 to the first mixing chamber 10 can be realized.

It is advantageous when the cross section of the fluid communication 14 is not too great and the length of a fluid communication 14 is not too small. It is preferred that the maximum cross section of a fluid communication is, for instance, 1 to 3 mm, more particularly 1.5 to 2.5 mm. Preferably, the length of the fluid communication 14 is, for instance, 2 to 5 cm, more particularly 3 to 4 cm. Such cross sections that are not too large and lengths that are not too short of the fluid communication 14 prevent the storage space 8 from emptying undesirably rapidly when the second fluid is, for instance, a low viscous product. What can be achieved with such cross sections that are not too great and lengths that are not too short of a fluid communication is, that a fluid communication of a particular size is suitable for use in different holders containing different sorts of second fluids. Here, for such a fluid communication of a specific size, a matching protrusion receiving recess 160 of the holder receiving portion 157 can be used, so that the protrusion receiving recess 160 is also suitable for different holders with different sorts of second fluids.

The exchangeable holder can be manufactured by means of the method described hereinafter. The first holder part 198 with the substantially flat contacting surface 160 and the substantially flat second holder part are provided. The storage space(s) 8, 8B and the first mixing chamber 10, and, optionally, the outflow channels 182, the fluid communication(s) 14, 14B, the fluid inlet chamber(s) 186 and/or the chamber 180 are provided in the first holder part, each comprising a wall offset relative to the contacting surface, which, each, form part of the first holder part. The second holder part 199 is contacted against the contacting surface of the first holder part. Preferably, the second holder part is connected to the contacting surface of the first holder part after, preferably, the storage space(s) 8, 8B is/are filled with the second fluid.

If the first holder part is substantially plate-shaped, the at least one protrusion (173, 174, 175, 177, 178) can be formed on the plate-shaped first holder part by means of, for instance vacuum formation, thermo formation, pressing, deep-drawing and/or deep-pressing, such that the storage space and the first mixing chamber, and, optionally, the first outflow channels, the fluid communication(s), the fluid inlet chamber(s) and/or the chamber 180 are each, at least partly, bounded by the at least one protrusion.

The invention not limited in any manner to the embodiments outlined hereinabove. In the embodiment according to FIG. 2b, the storage spaces are side by side. It is also possible that the storage spaces are located one above the other. Further, instead of one or two storage spaces for the second fluids, an exchangeable holder can also comprise more than two storage spaces for the second fluids. As a consequence, the holder can comprise, instead of one or two fluid communications, also, more than two fluid communications. The second fluids are, for instance, mixable and/or soluble in the first fluid.

In the example, the storage spaces were filled with coffee concentrate and/or milk concentrate. Other second fluids, based or not based on concentrate are also conceivable, here, for instance a squash or powder for preparing a lemonade can be considered. The apparatus may further be provided with additional storage spaces that may be filled with additives such as, for instance, soluble powders or concentrates. These powders too may be supplied to the first mixing chamber by, for instance, forcing out through a third fluid, or by emptying the respective storage space through squeezing. Here, for instance, flavour enhancers, sugars, cocoa and the like can be involved. Also, milk powder and/or milk creamer can be considered. Generally, it holds that, apart from a liquid such as a concentrate, the second fluid can also be a powder and the like, soluble in the first fluid or mixable with the first fluid, for instance soluble in a liquid such as water. A second fluid in the storage space can also comprise both a concentrate and a powder, in mixed form or not in mixed form.

In the examples given hereinabove, the dosing device can dispense the second fluid under pressure to the first chamber. As a result, in the embodiment according to FIGS. 2a, 2b, 3 and 6a-6e, the beverage cannot flow back into the storage space 8. It is also conceivable that the dosing device is an active dosing device that dispenses the second fluid by means of a pump.

In each of the outlined embodiments, the first fluid can be a gas such as steam. Then, the second fluid will usually already comprise a beverage to which, in the first mixing chamber 10, the gas is added by, for instance, heating the beverage. The gas can also comprise carbonic acid gas (CO₂) for obtaining a carbonated beverage. The first fluid can also comprise both a liquid and a gas.

In the embodiment of FIG. 1, the restriction is part of the apparatus and the supply channel is part of the holder. Naturally, also, both the restriction and the supply channel can be fixedly connected to the apparatus or both be fixedly connected to the holder.

In the embodiments outlined hereinabove, the first fluid is supplied to the first mixing chamber during at least a first period, and the second fluid is supplied to the first mixing chamber during at least a second period. Here, the first and second period can start and finish simultaneously. It is also possible that the second period starts earlier than the first period. However, other variations are also possible.

Further, the fluid dispensing device 6 can be designed for dispensing, at wish, different types of first fluids, such as steam, water, CO₂ et cetera. The selection hereof can be regulated with the control device 34 and will often be connected to the type of second fluid or second fluids in the exchangeable holder. If desired, this choice can also be set manually or with the aid of the code reading unit 52.

The temperature of the first fluid can vary. For instance, the first fluid can also consist of water at room temperature or cold water. The temperature of the first fluid that is supplied to the holder for preparing a beverage can also vary over time.

Instead of tearable skins, the seals 38 can also comprise valves known per se which are operated by the apparatus, in order to be opened.

If the holder is provided with different storage spaces, one (1) needle can be pierced in the holder for supplying the third fluid to the second fluids in the different storage spaces. Here, the needle is pierced in a wall of the holder at a position below which there is a space which is in fluid communication or can be brought in fluid communication with the storage spaces. However, it is also possible that per storage space, a needle is pierced in a wall of the holder. Here, this may be in a wall of the respective storage spaces themselves or in a wall of the holder, at positions below which are located different spaces which are or can be brought, respectively, in fluid communication with the different storage spaces.

In the preceding examples, the needle was pierced into the holder by activating the dosing device by pushing the button. However, it is also possible that the needle is pierced into the holder manually. The needle may be attached to a lid of the apparatus. The apparatus is then provided with, for instance, a receiving space for the holder which can be closed off by the lid. By closing the storage space with the lid, the (at least one) needle can then be pierced into the holder.

The holder can further also comprise an assembly of separate first and/or second holder parts, for instance an assembly of separate blister packs, an assembly of separate packages of a different type, or an assembly of one or more blister packs with one or more packages of a different type. Optionally, parts of such an assembly can be designed so as to be separable, for instance tearable, so that users can for instance remove parts of the holder when they want to prepare, for instance, a cup of coffee without milk.

The fluid communication seal needs not necessarily be located on or near the transition from a storage space to the fluid communication. The fluid communication seal can for instance also be located on or near the transition from the fluid communication to the first mixing chamber, or be, for instance, an interruption of the channel of the fluid communication.

Such variants are each understood to fall within the framework of the invention. The temperature of the first fluid can vary. The first fluid may also consist of water at room temperature or cold water. Also, the temperature of the first fluid that is supplied to the holder for preparing a beverage can vary over time.

The volume of a storage space can for instance vary from 5 to 150 ml, more particularly from 6 to 50 ml. A passage opening of the restriction can for instance vary from 0.4 to 1.5 mm, more particularly from 0.6 to 1.3 mm, still more particularly from 0.7 to 0.9 mm. The pressure at which, in use, the liquid dispensing device dispenses the first fluid can vary from 0.6 to 12 bars, more particularly from 0.7 to 2 bars, preferably from 0.9 to 1.5 bars. The period during which the first fluid is supplied to the first mixing chamber for preparing the beverage can vary from 2 to 90 seconds, more particularly from 10 to 50 seconds. The size of the air inlet opening, when this is fully opened, can be, for instance, 0.005 to 0.5 mm².

1. A system for preparing a predetermined amount of beverage suitable for consumption, the system comprising:
an exchangeable holder and an apparatus provided with a fluid dispensing device which is detachably connected to the holder for dispensing, under pressure, at least one amount of at a first fluid such as a liquid and/or a gas, in particular such as water and/or steam, to the exchangeable holder, wherein the exchangeable holder includes:
at least one storage space which is filled with a second fluid such as a concentrate,
at least a first mixing chamber,
at least one outflow opening which is in fluid communication with the first mixing chamber for dispensing the beverage from the first mixing chamber,
at least one fluid communication between the storage space and the first mixing chamber for dispensing the second fluid to the first mixing chamber and at least one inlet opening which is detachably connected to an outlet opening of the fluid dispensing device for supplying the first fluid to the first mixing chamber,
a dosing device which is designed for supplying the second fluid in a dosed manner from the storage space to the first mixing chamber,
a restriction which is included in a fluid flow path which extends via the outlet opening and the inlet opening from the fluid dispensing device to the first mixing chamber for generating with the restriction,
a jet of the first fluid which is supplied to the first mixing chamber so that in the first mixing chamber, the first fluid and the second fluid mix together for obtaining the beverage which then leaves the holder via the outflow opening,
a narrow passage which is included in the fluid flow path between the restriction and the first mixing chamber for, on the one side, allowing the jet of the first fluid to pass from the restriction to the first mixing chamber and, on the other side, for substantially preventing the first fluid, the second fluid and/or the beverage from proceeding from the first mixing chamber through the narrow passage in the direction of the restriction.

2. A system according to claim 1, wherein the narrow passage has a cross section such that, in use, the narrow passage forms a free passage for the jet.

3. A system according to claim 1, wherein the narrow passage has a cross section such that, in use, the jet substantially prevents the first fluid, the second fluid and/or the beverage from flowing from the first mixing chamber through the narrow passage to the restriction.

4. A system according to claim 1, wherein a cross section of the narrow passage substantially corresponds to a cross section of the jet of the first fluid at the location of the narrow passage.

5. A system according to claim 1, wherein a cross section of the narrow passage is 1-2 times a cross section of the jet of the first fluid at the location of the narrow passage.

6. A system according to claim 1, wherein a cross section of the narrow passage is 1.05-1.25 times a cross section of the jet of the first fluid at the location of the narrow passage.

7. A system according to claim 1, wherein the mixing chamber comprises a first entrance opening and a second entrance opening placed at a distance from the first entrance opening while, in use, the first fluid enters the first mixing chamber via the first entrance opening and the second fluid enters the first mixing chamber via the second entrance opening.

8. A system according to claim 7, wherein the at least one fluid communication terminates into the second entrance opening and wherein the inlet opening is in fluid communication with the first entrance opening.

9. A system according to claim 1, wherein the narrow passage forms part of the exchangeable holder.

10. A system according to claim 1, wherein the narrow passage is formed by a passage restriction which is included in the fluid flow path between the restriction and the first mixing chamber.

11. A system according to claim 1, wherein the narrow passage is formed by at least a part of a passage channel which is included in the fluid flow path between the restriction and the first mixing chamber.

12. A system according to claim 11, wherein at least one transverse dimension of the passage channel decreases in the direction from the restriction to the first mixing chamber.

13. A system according to claim 10, wherein at least one transverse dimension of the passage channel increases in the direction from the restriction to the first mixing chamber.

14. A system according to claim 1, wherein the restriction forms part, at least partly, of the fluid dispensing device.

15. A system according to claim 1, wherein the restriction is completely included in the fluid dispensing device.

16. A system according to claim 10, wherein the passage channel forms part, at least partly, of the exchangeable holder.

17. A system according to claim 16, wherein a part of the passage channel which is in contact with a wall of the first mixing chamber, forms part of the exchangeable holder.

18. A system according to claim 16, wherein the passage channel is completely included in the exchangeable holder.

19. A system according to claim 1, wherein the holder is further provided with an air supply for supplying air to the first fluid.

20. A system according to claim 17, wherein the air supply terminates into the fluid flow path, upstream of at least a narrowest point of the narrow passage.

21. A system according to claim 1, wherein the dosing device is designed for said dosed supply of the second fluid from the at least one storage space to the first mixing chamber by means of supplying a third fluid, such as a gas or a liquid, in a controllable manner, under pressure, to the second fluid in the storage space.

22. A system according to claim 1, wherein the dosing device for said dosed supply of the second fluid from the at least one storage space to the first mixing chamber is provided with a compressing unit for compressing the at least one storage space.

23. A system according to claim 1, wherein the system is further provided with a holder receiving portion which is designed for detachably receiving the holder, which holder receiving portion is provided with at least one holder receiving recess for receiving the storage space and/or the first mixing chamber and/or the fluid communication, which at least one holder receiving recess, viewed in a flat cross-section of the holder with the holder received in the holder receiving portion, has contours which correspond at least partly to contours of the storage space and/or the first mixing chamber and/or the fluid communication.

24. A system according to claim 23, wherein the contours of the holder receiving portion correspond substantially completely to the contours of the storage space and/or the first mixing chamber and/or the fluid communication.

25. An exchangeable holder designed to be connected to an apparatus for providing a system for preparing a predetermined amount of beverage suitable for consumption and having a fluid dispensing device for dispensing at least a first fluid, such as a gas and/or liquid, under pressure to the exchangeable holder for preparing a beverage suitable for consumption, the exchangeable holder comprises:
at least one storage space which is filled with a second fluid, such as a concentrate,
at least a first mixing chamber,
at least one outflow opening which is in fluid communication with the first mixing chamber for dispensing the beverage from the first mixing chamber,
at least one fluid communication between the storage space and the first mixing chamber for dispensing the second fluid to the first mixing chamber, and
at least one inlet opening which is detachably connected, in use, to an outlet opening of the fluid dispensing device for supplying the first fluid to the first mixing chamber,
a restriction in the system which is included in a fluid flow path which extends via the outlet opening and the inlet opening from the fluid dispensing device to the first mixing chamber for generating, with the restriction, a jet of the first fluid which is supplied to the first mixing chamber, so that, in the first mixing chamber, the first fluid and the second fluid mix together for obtaining the beverage which then leaves the exchangeable holder via the outflow opening,
a narrow passage which is included in the fluid flow path between the restriction and the first mixing chamber for, on the one side, allowing the jet of the first fluid to pass from the restriction to the first mixing chamber, and, on the other side, for substantially preventing the first fluid, the second fluid and/or the beverage from proceeding from the first mixing chamber through the narrow passage in the direction of the restriction.

26. An exchangeable holder according to claim 25, wherein the narrow passage has a cross section such that, in use, the narrow passage forms a free passage for the jet.

27. An exchangeable holder according to claim 25, wherein the narrow passage has a cross section such that, in use, the jet substantially prevents the first fluid, the second fluid and/or the beverage from flowing from the first mixing chamber through the passage channel to the restriction.

28. An exchangeable holder according to claim 25, wherein a cross section of the narrow passage substantially corresponds to a cross section of the jet of the first fluid at the location of the narrow passage.

29. An exchangeable holder according to claim 25, wherein a cross section of the narrow passage is 80%-160% of a cross section of the jet of the first fluid at the location of the narrow passage.

30. An exchangeable holder according to claim 25, wherein a cross section of the narrow passage is 100%-125% of a cross section of the jet of the first fluid at the location of the narrow passage.

31. An exchangeable holder according to claim 25, wherein the first mixing chamber comprises a first entrance opening and a second entrance opening placed at a distance from the first entrance opening, while, in use, the first fluid enters the first mixing chamber via the first entrance opening and the second fluid enters the first mixing chamber via the second entrance opening.

32. An exchangeable holder according to claim 31, wherein the at least one fluid communication terminates into the second entrance opening and wherein the inlet opening is in fluid communication with the first entrance opening.

33. An exchangeable holder according to claim 25, wherein the narrow passage is formed by a passage restriction which is included in the fluid flow path between the restriction and the first mixing chamber.

34. An exchangeable holder according to claim 25, wherein the narrow passage is formed by, at least a part of, a passage channel which is included in the holder in the fluid flow path between the restriction and the first mixing chamber.

35. An exchangeable holder according to claim 34, wherein at least one transverse dimension of the passage channel decreases in the direction from the restriction to the first mixing chamber.

36. An exchangeable holder according to claim 34, wherein at least one transverse dimension of the passage channel increases in the direction from the restriction to the first mixing chamber.

37. An exchangeable holder according to claim 25, wherein the holder is free of the restriction for generating the jet of the first fluid with the restriction.

38. An exchangeable holder according to claim 25, wherein the holder is further provided with an air supply for supplying air to the first fluid.

39. An exchangeable holder according to claim 38, wherein the air supply terminates into the fluid flow path, upstream of at least a narrowest point of the narrow passage.

40. An exchangeable holder according to claim 25, wherein the holder is designed such that, in use, by the apparatus, a third fluid can be supplied, in a controllable manner, under pressure to the second fluid in the at least one storage space for dispensing the second fluid in a dosed manner from the at least one storage space to the first mixing chamber while, in use, the first fluid is also supplied under pressure to the first mixing chamber so that the second fluid and the first fluid mix together for obtaining the beverage which then leaves the holder via the outflow opening.

41. An exchangeable holder according to claim 40, further comprising means, cooperating with the apparatus for supplying, in use, with the apparatus, the third fluid to the second fluid in the at least one storage space, the means cooperating with the apparatus for instance comprising a locally weakened area of a wall of the holder for, in use, piercing a needle of the dosing device through this area for supplying the third fluid to the second fluid in the at least one storage space.

42. An exchangeable holder according to claim 25, wherein the at least one storage space is bounded, at least partly, by a wall of a flexible or deformable material such as a foil so that the storage space can be squeezed together for said dosed supply of the second fluid from the at least one storage space to the first mixing chamber.

43. An apparatus for use in a system according to claim 1.

44. An exchangeable holder according to claim 25, further comprising a holder receiving portion which is designed for detachably receiving the holder for preparing a beverage suitable for consumption, which holder receiving portion is provided with at least one holder receiving recess for receiving the storage space and/or the first mixing chamber and/or the fluid communication, which at least one holder receiving recess has contours, viewed in a flat cross-section of the holder with the holder received in the holder receiving portion, which correspond, at least partly, to contours of the storage space and/or the first mixing chamber and/or the fluid communication.

45. An exchangeable holder according to claim 44, wherein the contours of the holder receiving portion correspond substantially completely to the contours of the storage space and/or the first mixing chamber and/or the fluid communication.
